(19) United States
(12) Patent Application Publication
(10) Pub. No.: US 2018/0240360 A1
(43) Pub. Date: Aug. 23, 2018

(54) Dough cutters used to create objects to elicit letter sounds for educational learning and speech development.

(71) Applicant: Andrea G Smith, Rock Hill, SC (US)

(72) Inventor: Andrea G Smith, Rock Hill, SC (US)

(21) Appl. No.: 15/436,772

(22) Filed: Feb. 18, 2017

(51) Int. Cl. G09B 19/04; A63H 33/00

(52) U.S. Cl. CPC G09B 19/04; A63H 33/001

(57) ABSTRACT

An interactive hands-on approach for speech and letter sound production. Sets of dough cutters are designed categorized by sound pattern or phoneme placement and used in teaching children through repetition of words/objects containing these sounds. Sound patterns are chosen to address with children and dough cutters are used to make target words into three dimensional sound shapes and expand with repetition of sounds and use of pivot phrases.

### CROSS-REFERENCE TO RELATED APPLICATIONS

Application Number: 15/436, 772

Filing Date: Feb. 18, 2017

### STATEMENT REGARDING FEDERALLY SPONSORED RESEARCH OF DEVELOPMENT

Not Applicable

### REFERENCE TO A “SEQUENCE LISTING”

Not Applicable

### BACKGROUND OF THE INVENTION

As a speech-language pathologist, I have worked with special needs and language delayed children for the past 10 years. In my profession, I have used various manipulatives to work with children on sound production. Children with apraxia have a disorganization of speech and require lots of repetition to produce sound patterns. There are articulation/phonology cards to help children with these specific sound patterns but there are not many hands-on manipulatives. I wanted to create a product that children could use to create three-dimensional shapes that were representative of the sound patterns they struggled with. Children love modeling dough and in creating sound specific cutters, they are able to get the repetition they need with an interactive product that meets many learning modalities.

### BRIEF SUMMARY OF THE INVENTION

Sets of dough cutters are designed categorized by sound pattern or phoneme placement and used in teaching children through repetition of words/objects containing these sounds. Along with illustrated articulation cards, speech pathologists/parents/teachers are able to choose the sounds they want to target and use cutters to help with repetition and create an interactive learning environment. The purpose of this invention is to help children learn speech sound and patterns of sounds more efficiently and to see more growth in the therapy setting and across all environments.

### BRIEF DESCRIPTION OF DRAWINGS

FIG. 1 is an outline used to create 3-d image

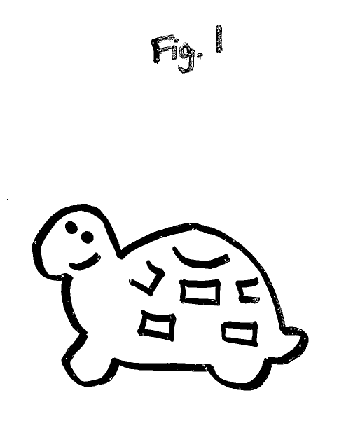

FIG. 2 is the 3-d image for prototype

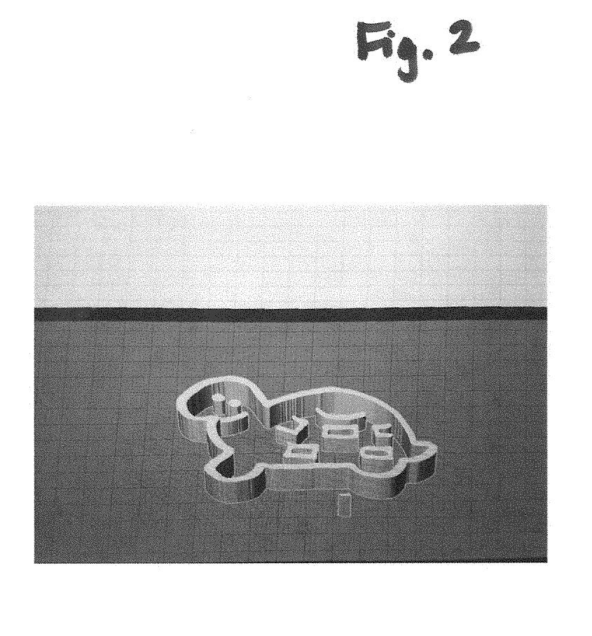

FIG. 3 is the master

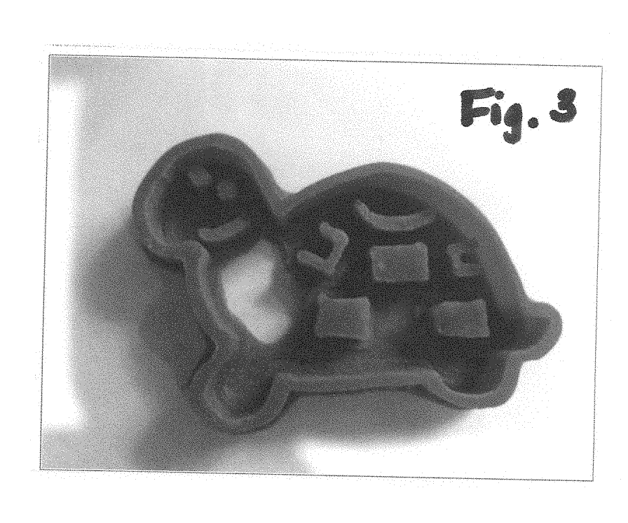

FIG. 4 is the accompanying articulation card

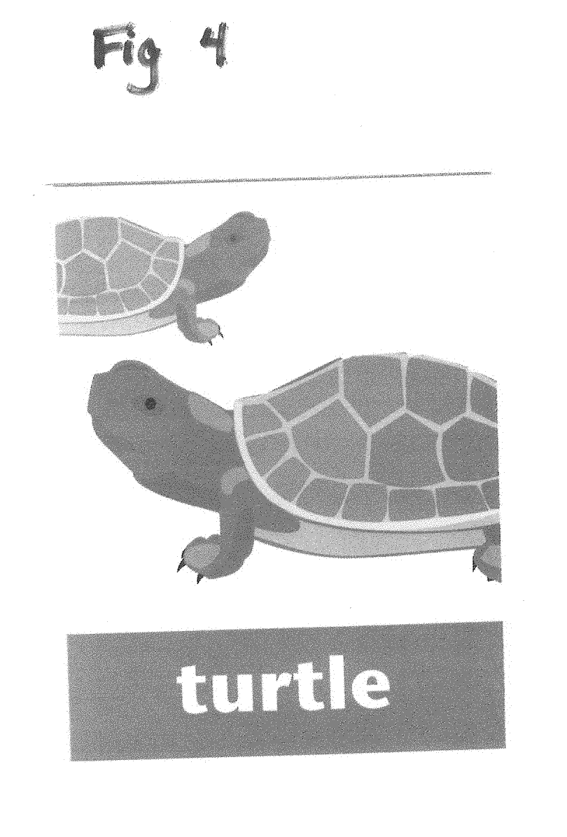

### DETAILED DESCRIPTION OF THE INVENTION

After carefully selecting sound combinations or letter sounds to be addressed, an object is chosen to represent the sounds and an outline is used to create a 3-D image for printing. 3-D image is created and sent to 3-D extruder for prototyping. After prototyping is concluded, a master is made for production. An illustrated articulation card is used in conjunction with cutter for sound production.

1. A method for speech sound and letter production, comprising of:
use of dough cutter designed for specific sound, and
providing repetition and multimodal learning, and
accompanied by an illustrated articulation card, whereby said cutter is used in conjunction with dough and card to obtain learning of speech sounds.
